(19) United States
(12) Patent Application Publication
(10) Pub. No.: US 2007/0133561 A1
(43) Pub. Date: Jun. 14, 2007

(54) Apparatus and method for performing packet scheduling using adaptation round robin

(76) Inventors: Hong Soon Nam, Daejeon (KR); Kwang Suk Song, Daejeon (KR); Bong Tae Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/633,740

(22) Filed: Dec. 5, 2006

(30) Foreign Application Priority Data
Dec. 8, 2005 (KR) 10-2005-0120244

(51) Int. Cl. H04L 12/56

(52) U.S. Cl. 370/395.41

(57) ABSTRACT

A packet scheduling apparatus and method using an adaptation round-robin method is disclosed. In order to schedule services of a plurality of flows over a high-speed communication network in which the flows share a single link, the packet scheduling method includes the steps of: a) receiving various-sized packets, and storing the received packets while being classified according to flows on the basis of packet flow information of individual packets; b) if a flow to be serviced is transitioned from an idle mode to an active mode, adding an identifier (ID) of the corresponding flow to the tail of an active flow list; c) if the corresponding flow's, ID is located at the top of the active flow list, providing a head packet of the corresponding flow; d) increasing a service count by a predetermined number corresponding to the size of the serviced packet, and establishing a maximum service count; e) providing the next packet in consideration of the service count of the service flow and a next-packet size; and f) if the service count of the corresponding flow and the next-packet size are higher than the maximum service count, providing the next flow. Therefore, service fairness and low latency are implemented.

### RELATED APPLICATION

The present application is based on, and claims priority from, Korean Application Number 10-2005-0120244, filed Dec. 8, 2005, the disclosure of which is incorporated by reference herein in its entirety.

### BACKGROUND OF THE INVENTION

1. Field of the Invention

The present invention relates to a method and apparatus for performing a packet scheduling over a high-speed communication network, and more particularly to a method and apparatus for performing a packet scheduling using an adaptation round-robin scheme.

2. Description of the Related Art

Generally, a plurality of flows share limited resources over a communication network, resulting in the occurrence of temporary congestion. If the congestion occurs, a scheduling process is performed in various ways, such that the scheduling process can provide fairness among several flows and can also limit latency among the flows.

A scheduler for use in a high-speed communication network must limit fairness and latency among a plurality of flows, and must be operated at high speed, such that time complexity must be low. For example, a packet having the length of 100 bytes at 10 Gbps interface must be processed within 0.08 μsec.

A representative conventional scheduling method has been disclosed in U.S. Pat. No. 6,101,193. However, the above-mentioned scheduling method has low fairness and high latency, whereas it has low time complexity.

Another conventional scheduling method has been disclosed in U.S. Pat. No. 6,134,217. However, although the above-mentioned scheduling method has superior fairness and latency, it has a disadvantage in that it increases time complexity according to the number of flows due to the sorting caused by a time stamp.

A conventional round-robin method must control an amount of data receivable in a single round to be higher than a maximum packet size. If the maximum packet size is set to an excessively large size, a large amount of data is provided to a single round, resulting in the reduction of fairness among several flows.

There are a variety of conventional round-robin methods, for example, a Deficit Round Robin (DRR) method proposed by M. Shreedhar and George Varghese, who have published a research paper entitled “Efficient Fair Queuing using Deficit Round Robin” in SIGCOMM '95, pp. 231˜241, and a Elastic Round Robin (ERR) method disclosed in a research paper entitled “Fair and Efficient Packet Scheduling Using Elastic Round Robin” in IEEE Transactions on Parallel and distributed systems Vol. 13, No. 3, 2003, pp. 324˜336. The above-mentioned conventional round-robin methods have time complexity of O(1).

The above-mentioned conventional method does not pre-establish the size of a maximum serviceable packet, determines an amount of a serviceable packet for each round start time, and provides the determined serviceable packet amount.

The DRR method controls a deficit count operation which manages a quantum indicative of a packet amount assigned to a single round and the remaining packet after the service. In more detail, if one of several flows initially receives the service, the DRR method assigns the deficit count to the quantum, provides the service for the packet smaller than the deficit count, and reduces the deficit count by the packet service amount. The DRR method continuously provides the service until the next packet is not larger than the deficit count. If the next packet is larger than the deficit count, the DRR method does not provide the service, holds the deficit count, and provides the next flow. If a new round begins, the deficit count of flow i receives a new quantum, such that the deficit count DCᵢ is changed to a new deficit count as denoted by DCᵢ←DCᵢ+Quantum.

However, according to the above-mentioned DRR method, a first packet smaller than the deficit count receives a few packets, a second packet larger than the deficit count receives a new quantum in the next round.

The above-mentioned DRR method controls the quantum size, and controls an amount of data receivable in a single round for each flow, such that it may control a bandwidth for each flow. In other words, if the DRR method provides a corresponding service on the condition that a quantum for a high-speed flow is set to a high value and the other quantum for a low-speed quantum is set to a low value, it can provide the service at speed proportional to the above-mentioned quantum.

The above-mentioned DRR method must set a quantum size to a specific size larger than a maximum packet size to maintain the time complexity of O(1). If the quantum is set to a high value, fairness and latency are deteriorated.

In the meantime, the ERR (Elastic Round Robin) method determines an amount of data serviceable in the next round in consideration of the size of a real service packet, and improves fairness and latency, differently from the above-mentioned DRR method. The ERR method manages not only a surplus counter continuously provided until reaching a negative(−) value, but also maximum surplus count indicative of a maximum surplus count within a single round. The surplus count is initially set to “1”, is provided if a packet arrives, and is set to a positive(+) value. Therefore, if the ERR method services the packet, and subtracts the packet size from the surplus count, the surplus count becomes a negative value, such that the ERR method terminates the service of the corresponding flow, and begins a service of the next flow. In this case, the surplus count is changed to a new surplus count acquired when the service packet amount is subtracted from the old surplus count, such that the old surplus count is updated to the new surplus count as denoted by SCᵢ(r)←Sentᵢ(r)−SCᵢ(r). In this way, if the service for a single round is terminated as described above, the ERR method searches for a maximum surplus count at the “r−1” round indicative of a previous round of the “r” round, calculates an allowable value Aᵢ(r) of each flow of the “r” round indicative of the next round of the “r−l” round, and updates a surplus count SCᵢ(r), as denoted by the following equation 1:
SCᵢ(r)←Sentᵢ(r)−Aᵢ(r)
Aᵢ(r)←1+MaxSC(r−1)−SCᵢ(r−1) [Equation 1]

The above-mentioned ERR method is more effectively operated in a specific condition in which a user does not know the maximum packet size than in the DRR method, and reflects the maximum service count (MaxSC) of a previous round to a current round, such that fairness and latency can be greatly improved. On the other hand, the ERR method recognizes start and end points of each round, updates the maximum service count (MaxSC) according to the recognized start and end points of each round, and updates the service count (SC) value at the start point of each round, resulting in the reduction of fairness or latency between two flows during a single round. In addition, the ERR method determines a serviceable data amount of the current round according to the previous round value instead of the current round value, such that it unavoidably encounters a one-round delay.

There are a variety of scheduling methods based on the time stamp, for example, a self-clocked fair queuing method proposed by S. J. Golestani, who has published a research paper entitled “A self-clocked fair queuing scheme for high speed applications” in Proc. INFOCOM '94, pp. 636˜646 on April 1994; a virtual clock method; a starting potential fair queuing method proposed by D. Stidialis and A. Varma, who have published a research paper entitled “Efficient Fair Queuing Algorithms for Packet-Switched Networks” in IEEE/ACM Transactions on Networking, Vol. 6, No. 2, pp. 175˜185 on April 1998; and a high-speed packet scheduling method and apparatus disclosed in United States Patent No. US005905730A filed on 18 May 1999, etc.

However, although the above-mentioned time-stamp-based scheduling method has superior fairness and latency, it has time complexity of at least O(log(N)) to achieve sequence arrangement caused by the time stamp. In addition, the above-mentioned time-stamp-based scheduling method increases time complexity according to the number of flows, such that it is difficult to be implemented in a high-speed communication network including a large number of flows.

In addition, a large number of flows (also called a large number of connections) share with one another in a general communication network, and a variety of speeds and a variety of transmission packet sizes are requested by individual flows. In conclusion, there must be developed a scheduling apparatus and method capable of providing the above-mentioned requested speeds of individual flows and service fairness, and reducing latency.

### SUMMARY OF THE INVENTION

Therefore, the present invention has been made in view of the above problems, and it is an object of the present invention to provide a packet scheduling method and apparatus for allowing a plurality of flows having various packet sizes to effectively use limited network resources.

It is an object of the present invention to provide a packet scheduling method and apparatus using an adaptation round-robin method, which sequentially provides all the flows over a high-speed optical communication network, provides an amount of data serviceable at one time according to an amount of data received in other flows, and performs a packet scheduling operation to improve fairness and latency.

In accordance with one aspect of the present invention, the above and other objects can be accomplished by the provision of a packet scheduling method using an adaptation round-robin method comprising the steps of: a) receiving various-sized packets, and storing the received packets while being classified according to flows on the basis of packet flow information of individual packets; b) if a flow to be serviced is transitioned from an idle mode to an active mode, adding an identifier (ID) of the corresponding flow to the tail of an active flow list; c) if the corresponding flow's ID is located at the top of the active flow list, providing a head packet of the corresponding flow; d) increasing a service count by a predetermined number corresponding to the size of the serviced packet, and establishing a maximum service count; e) providing the next packet in consideration of the service count of the service flow and a next-packet size; and f) if the service count of the corresponding flow and the next-packet size are higher than the maximum service count, providing the next flow.

In accordance with another aspect of the present invention, there is provided a packet scheduling apparatus using an adaptation round-robin method comprising: a flow queue for receiving various-sized packets, and storing the received packets while being classified according to flows on the basis of packet flow information of individual packets; a service counter for increasing a service amount by a serviceable packet amount of the individual flows, and establishing a resultant service count; a maximum service counter for establishing a maximum service count indicative of a maximum service amount of the individual flows; and an active flow list unit for adding an identifier (ID) of the corresponding flow to the tail of an active flow list when the corresponding flow to be serviced is transitioned from an idle mode to an active mode, controlling a flow from a head flow to output the packets as large as a data amount allowed by the service count of the corresponding flow, and adding an identifier (ID) to the tail of the active flow list when a packet exceeding the maximum service count remains in the output flow, such that the remaining packet is provided to the next round.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a router for routing a packet over a high-speed communication network according to the present invention;

FIG. 2 is a block diagram illustrating a packet scheduling apparatus for performing a packet scheduling operation using an adaptation round-robin method over a high-speed communication network according to a preferred embodiment of the present invention;

FIG. 3 is a flow chart illustrating a packet arrival process for use in the packet scheduling apparatus according to a preferred embodiment of the present invention;

FIG. 4 is a flow chart illustrating a packet output process for a packet scheduling service for use in the packet scheduling apparatus according to a preferred embodiment of the present invention;

FIG. 5 is a flow chart illustrating a method for managing a limited-sized count for use in the packet scheduling apparatus according to a preferred embodiment of the present invention; and

FIG. 6 is a graph of the result of a computer simulation illustrating a difference in fairness between the inventive packet scheduling apparatus and a conventional elastic round-robin (ERR) device according to the present invention.

### DESCRIPTION OF THE PREFERRED EMBODIMENTS

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

The round-robin method according to a preferred embodiment of the present invention selects at least one of all elements contained in a group in rational order. In more detail, the round-robin method sequentially selects one from among all elements contained in a list on a one-by-one basis in a direction from the top to the bottom of the list. If all elements are sequentially selected, the round-robin method returns to the top of the list.

The term “flow” according to a preferred embodiment of the present invention is indicative of a specific case in which one or more data streams distinguished from a packet header are merged with each other. The term “fairness” is indicative of a difference in an amount of service received in two flows during a specific time. The less the difference, the higher the fairness. The term “latency” is indicative of the degree of a received packet delay. The less the latency, the better the system.

A packet scheduling apparatus and method using an adaptation round-robin method over a high-speed communication network according to a preferred embodiment of the present invention will hereinafter be described with reference to the annexed drawings.

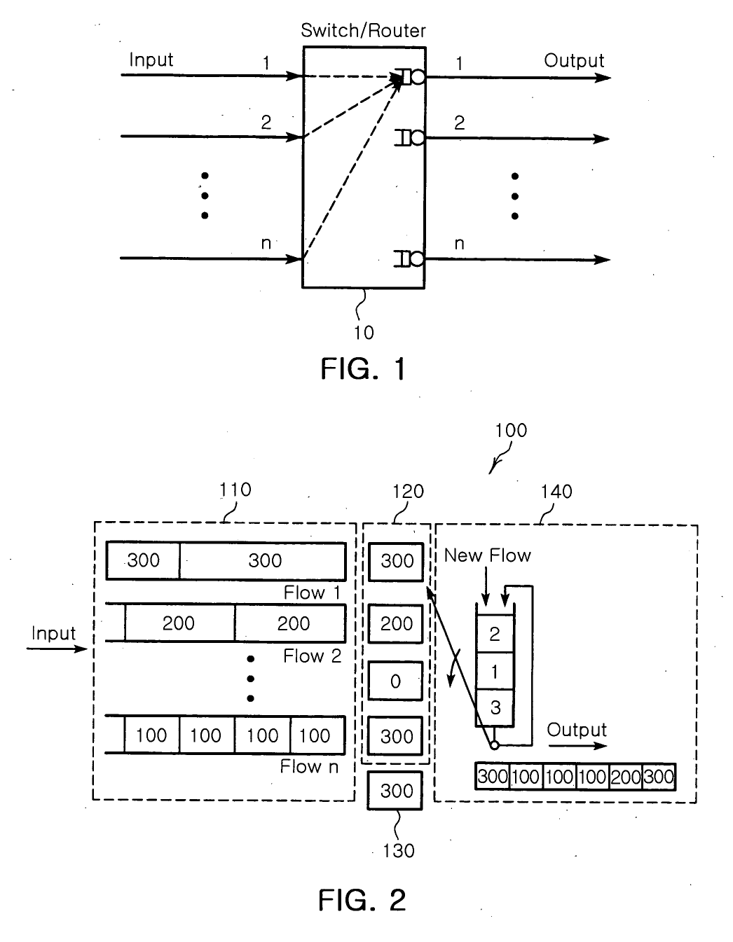

FIG. 1 is a block diagram illustrating a router for routing a packet over a high-speed communication network according to the present invention.

Referring to FIG. 1, the router (or the switch) 10 includes N input ports and N output ports. The router (or the switch) 10 is interoperable with a buffer (not shown) for temporarily storing a packet applied to the output port, and is also interoperable with a scheduler (not shown) for scheduling the packet stored in the buffer.

The router 10 switches the packet applied to each input port, and transmits the switched packet via a corresponding output port. If packets are simultaneously outputted to the same output port, the router 10 transmits the packets to the buffer, such that the packets are temporarily stored in the buffer.

If packets are concentrated on only one port from among a plurality of input ports, the concentrated packets may exceed a predetermined bandwidth of an output port. In order to solve the above-mentioned problem, the buffer temporarily stores received packets.

The scheduler provides the packets stored in the buffer in consideration of a Quality of Service (QoS) required by a predetermined order or sequence.

FIG. 2 is a block diagram illustrating a packet scheduling apparatus for performing a packet scheduling operation using an adaptation round-robin method over a high-speed communication network according to a preferred embodiment of the present invention.

Referring to FIG. 2, the packet scheduling apparatus (hereinafter referred to as a scheduler) 100 includes: a flow queue 110 for temporarily storing input packets while being classified according to individual flows; a service counter 120, a maximum service counter 130, an active flow list unit 140. In this case, a numeral of each packet contained in the flow queue 110 is indicative of a buffer size, numerals of the service counter 120 are indicative of a service amount for each flow, and the maximum service counter 130 is indicative of a maximum service amount.

If the packet arrives at the packet scheduler 100, the packet scheduler 100 classifies individual flows according to header information of the arrived packet, and stores the arrived packets in a corresponding flow queue 110 according to flow information. In this case, if a corresponding flow is changed from an idle state to an active state, the packet scheduling apparatus adds a corresponding flow identifier (ID) to the tail of the active flow list contained in the active flow list unit 140.

If the active flow list is not empty, the scheduler 100 firstly begins the service at a head flow from among several flows contained in the active flow list, provides the service by a specific data amount corresponding to an amount of data allowed in a service count. If the scheduler 100 provides all the waiting packets of a corresponding flow queue 110, it provides the next flow of the active flow. If there is a packet to be provided, the scheduler 100 stores a corresponding flow ID in the tail of the active flow list, allows the service to be made available in the next round, and updates the maximum service count 130. In this case, the same weight is assigned to all of the flows. Otherwise, if different weights are assigned to individual flows, the scheduler 100 includes a parameter indicative of a weight for each flow.

The service counter 120 establishes a service amount for each flow. In other words, the service counter 120 increases a service amount by the size of a service packet for each flow, and establishes the resultant service count according to the increased service amount result. The service counter 120 adds the next service packet to the previously-established service count value, such that it updates the service count to be used in the next packet service.

The maximum service counter 130 establishes a maximum service count of the above-mentioned service flow. In other words, the maximum service counter 130 sets the maximum service count to a predetermined value (e.g., a four-times size) according to a specific size which is equal to or higher than a maximum-sized packet from among the above-mentioned input packets. If the updated service count is higher than the maximum service count, or if the next-flow service is performed because a flow to be serviced is empty, the maximum service counter 130 updates the maximum service count.

Moreover, if a new-flow packet, which is not contained in the active flow list from among services of the active flow list unit 140, arrives at the maximum service counter 130, the maximum service counter 130 sets the service count of the new flow to a maximum service count. In this case, the service counter 120 and the maximum service counter 130 can be configured in the form of a simple counter and a comparator, and associated services are performed according to the order of data stored in the active flow list, resulting in the occurrence of time complexity of 0(1).

The active flow list unit 140 includes the active flow list for managing a plurality of flows, and adds a corresponding flow ID to the tail during the service time. Furthermore, if a new flow packet not contained in the active flow list from among a plurality of services arrives at the active flow list unit 140, the active flow list unit 140 adds the new flow packet to the tail of the active flow list.

A scheduling method according to a round-robin method to provide a plurality of flows having various packet sizes for use in the above-mentioned packet scheduling apparatus according to the present invention will hereinafter be described with reference to the annexed drawings.

Overall scheduling operations will hereinafter be described with reference to FIG. 2. As shown in FIG. 2, a packet having the size of 300 is stored in a first flow (Flow 1) of the flow queue 110, a packet having the size of 200 is stored in a second flow (Flow 2), and a packet having the size of 100 is stored in the flow N (Flow n). The service counter 120 of each flow receives a service count according to the size of packets stored in individual flows. The maximum flow counter 130 sets a maximum service count to a specific value “300” according to the packet size of the first flow (Flow 1).

If the active flow list is initially activated, the service counter 120 and the maximum service counter 130 of each flow contained in the scheduler 100 perform count initialization, such that their count values become “0”. The service counter 120 and the maximum service counter 130 provide the head packet of the first flow (Flow 1), and update the service count to “300”.

Therefore, since the service count is higher than the maximum service count, the service counter 120 and the maximum service counter 130 do not provide the service any more, update the maximum service count, and provides the second flow (Flow 2) in which the second flow's ID is added to the tail of the active flow list.

Provided that the head packet of the second flow (Flow 2) is provided, the service count of the second flow is set to “200”, and the next-packet service is provided, the resultant service count is higher than the maximum service count, such that the service is made unavailable. The maximum service count is maintained without any change, the second flow's ID is added to the tail of the active flow list, and then the service of a third flow (Flow 3) is provided.

A service of the head packet of the third-flow queue is performed, the above-mentioned service is continuously executed until the sum of the service count and the size of a packet to be serviced does not exceed the maximum service count, and a service of a head flow (e.g., Flow 1) contained in the active flow list is then executed.

The order of packets serviceable according to packet sizes is denoted by 300<200<100<100<1000<300, such that the aforementioned serviceable packets are provided according to the above-mentioned order. However, the conventional ERR method firstly provides a single service for each flow, updates the maximum surplus count, and provides a necessary service according to the updated maximum surplus count, such that the service order of a first round is denoted by 300<200<100<300, resulting in deterioration of fairness. Therefore, it can be readily recognized that service fairness is implemented according to the above-mentioned round-robin method.

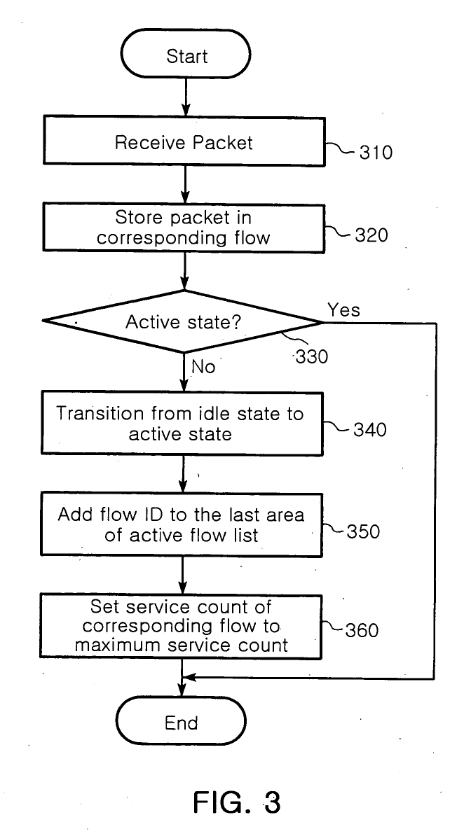

FIG. 3 is a flow chart illustrating a packet arrival process for use in the packet scheduling apparatus according to a preferred embodiment of the present invention.

Referring to FIG. 3, the scheduler 100 is switched by the switch (or router) 10 at step 310, and receives a packet temporarily stored in the buffer 20. The scheduler 100 stores the received packet in a corresponding flow queue 100 according to a flow ID of a corresponding packet at step 320.

The scheduler 100 determines whether the flow is in an active state at step 330. If the flow is in the active state at step 330, the scheduler 100 stops operations. Otherwise, if the flow is not in the active state at step 330, the scheduler 100 determines that an idle state is transitioned to an active state at step 340. Thereafter, the scheduler 100 adds the corresponding flow ID to the tail of the active flow list 130.

Thereafter, the scheduler 100 sets the service count of the corresponding flow to the maximum service count (Activelist[Tail[Activelist]]+←I) at step 360, and terminates all operations.

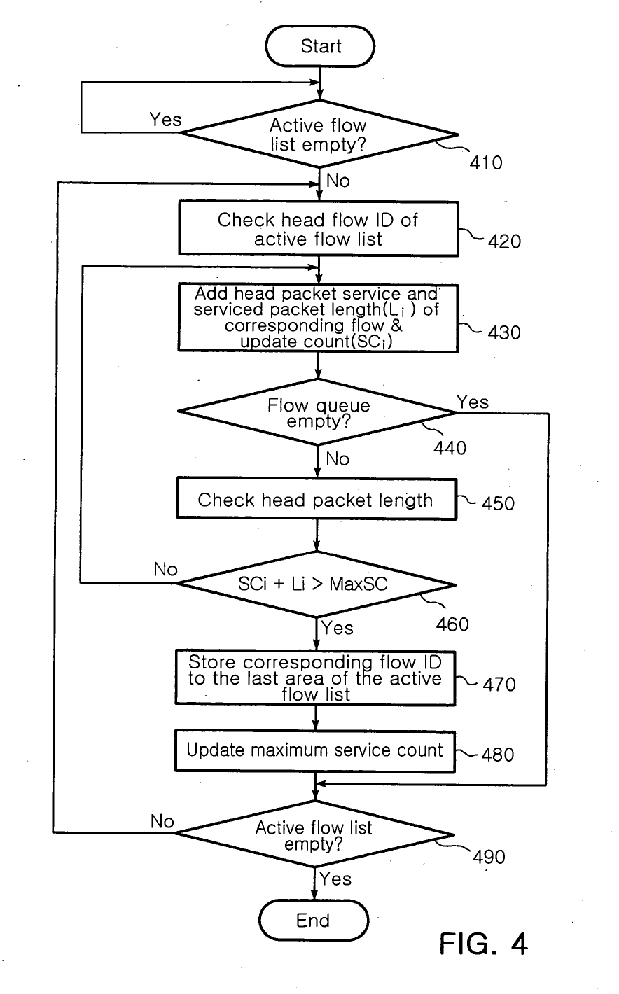

FIG. 4 is a flow chart illustrating a packet output process for a packet scheduling service for use in the packet scheduling apparatus according to a preferred embodiment of the present invention.

Referring to FIG. 4, the scheduler 100 determines whether the active flow list is transitioned from an empty state to an active state. In this case, the scheduler 100 determines whether the active flow list is in the empty state at step 410. If the active flow list is in the empty state at step 410, the scheduler 100 determines that the active flow list is in the empty state at step 410, and continuously maintains a standby mode. Otherwise, if the active flow list is not in the empty state at step 410, the scheduler 100 recognizes a flow ID of the head flow of the active flow list at step 420.

Thereafter, the scheduler 100 adds the head packet service and the packet length (Lᵢ) of a corresponding flow at step 430, and updates a service count SCᵢ. In more detail, provided that the corresponding flow ID is equal to “i”, the scheduler 100 provides the head packet (Pᵢ) of the corresponding flow queue 110, and sets a service count SCᵢ to the sum of the packet length (Lᵢ) of the corresponding flow and a pre-established service count using the service counter 130, as denoted by SCᵢ ←SCᵢ+Lᵢ.

The scheduler 100 provides the head packet, and determines whether the head packet is in an empty state (Flowi_que=empty) at step 440. If the flow queue 110 is in the empty state, the scheduler 100 goes to step 490. Otherwise, if the flow queue 110 is not in the empty state, the scheduler 100 determines the length of the head packet.

The scheduler 100 compares the SCᵢ+Lᵢ value with the maximum service count value (MaxSC) at step 460. If the SCᵢ+Lᵢ value is less than the MaxSC value at step 460, the scheduler 100 goes to step 430. Otherwise, if the SC_{i+L}ᵢ value is equal to or higher than the MaxSC value, the scheduler 100 stores the corresponding flow ID to the tail of the active flow list at step 470, and updates the MaxSC value at step 480.

Thereafter, the scheduler 100 determines whether the active flow list is in the empty state at step 490. If the active flow list is in the empty state at step 490, the scheduler 100 stops operations. Otherwise, if the active flow list is not in the empty state at step 490, the scheduler 100 returns to step 420 to provide the next flow.

If the flow queue 110 is in the empty state during the service time, the scheduler terminates a corresponding flow service, and provides the next flow according to the active flow list. If the sum of the corresponding flow count and the head packet size is higher than the maximum service count during the service time, the scheduler 100 does not provide the packet, and provides the packet to the next round. In this case, the flow ID of the corresponding flow is added to the tail of the active flow list. The above-mentioned service is continuously performed until the active flow list is transitioned to the empty state by the repetition of the above-mentioned operations.

A method for providing required bandwidths when individual flows require different bandwidths during the above-mentioned process will hereinafter be described in detail.

All flows have normalized weights “w”, respectively. If one flow (i.e., a first flow) has the “w” value of 1, and the other flow (i.e., a second flow) has the “w” value of 2, the second flow has a double bandwidth of a bandwidth of the first flow, and is able to receive a double service of a service of the first flow. Referring to the packet output process shown in FIG. 4, a packet generated after a first packet is serviced under a specific condition (SCᵢ+wLᵢ)≦MaxSC. If the specific condition (SCᵢ+wLᵢ)≦MaxSC is not established, the packet after the first packet is serviced at the next round. As shown in FIG. 4, the scheduler 100 determines whether a specific condition (SC/w>MaxSC) is established, such that it can determine a maximum packet size. If the SC/w value is high, the maximum service counter 130 updates the maximum service count (MaxSC) to the SCᵢ/w value.

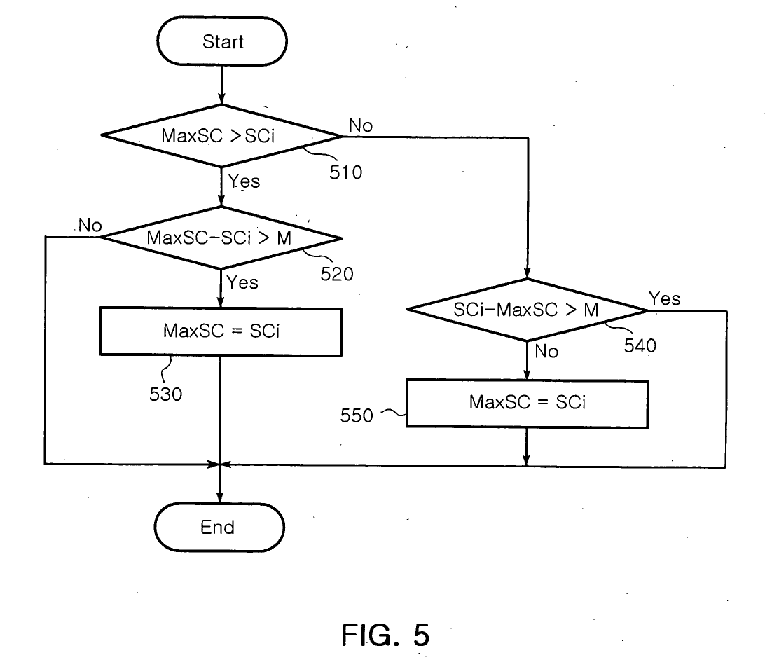

FIG. 5 is a flow chart illustrating a method for managing a limited-sized count for use in the packet scheduling apparatus according to a preferred embodiment of the present invention.

Referring to FIG. 5, if the service count and the maximum service count of each flow continuously increase whenever the service is received, an infinite number of counters are required. Indeed, it is impossible to implement the infinite number of counters, such that the packet scheduling apparatus must actually employ a limited-sized counter. Although the packet for use in a communication network is variable, its maximum packet size is limited. In this case, it is assumed that the maximum packet size is set to “M” equal to or higher than a maximum packet size capable of being contained in the communication network, and the counter size is equal to or higher than “4M”. If the service count is higher than “4M”, it returns to the value of 0, such that the counting operation re-begins at the value of 0.

Referring to FIG. 5, the packet scheduling apparatus determines whether the MaxSC value of the packet is higher than a service count (SCᵢ) of the corresponding packet at step 510. If the MaxSC value is higher than the service count (SCᵢ) of the corresponding packet at step 510, the packet scheduling apparatus determines whether the MaxSC value is higher than the service count (SCᵢ) of the corresponding packet by at least a specific value “M” at step 520. If the MaxSC value is higher than the service count (SCᵢ) of the corresponding packet by the specific value “M” or more, the packet scheduling apparatus updates the service count to the maximum service count (MaxSC) at step 530, and stops operations. Therefore, it can be recognized that the maximum service count (MaxSC) is higher than “4M” and the counting operation re-begins at the value of “0”, but the service count (SCᵢ) of the corresponding packet does not yet exceed the value of “4M”. Otherwise, if the MaxSC value is not higher than the service count (SCᵢ) of the corresponding packet by at least “M” at step 520, the packet scheduling apparatus does not update the MaxSC value, and maintains the MaxSC value without any change.

If the MaxSC value is not higher than the service count (SCᵢ) of the corresponding packet at step 510, the packet scheduling apparatus determines whether the service count of the corresponding packet is higher than the MaxSC value by at least “M” at step 540. If the service count of the corresponding packet is higher than the maximum service count (MaxSC) value by at least “M”, the packet scheduling apparatus does not update the MaxSC value, and maintains a current value. Therefore, it can be recognized that the maximum service count (MaxSC) is higher than “4M”, the counting operation re-begins at the value of “0”, and the service count of the corresponding packet does not yet exceed the value of “4M”. Otherwise, if the service count of the corresponding packet is not higher than the maximum service count (MaxSC) by at least “M”, the packet scheduling apparatus sets the MaxSC value to the service count (SCᵢ) at step 550, and stops operations. Namely, the packet scheduling apparatus compares the MaxSC value with the service count (SCᵢ), determines a bigger one of the two values, and updates the MaxSC value to the determined bigger value, because a difference between the service count of the flow having terminated the service and the MaxSC value is less than “M”.

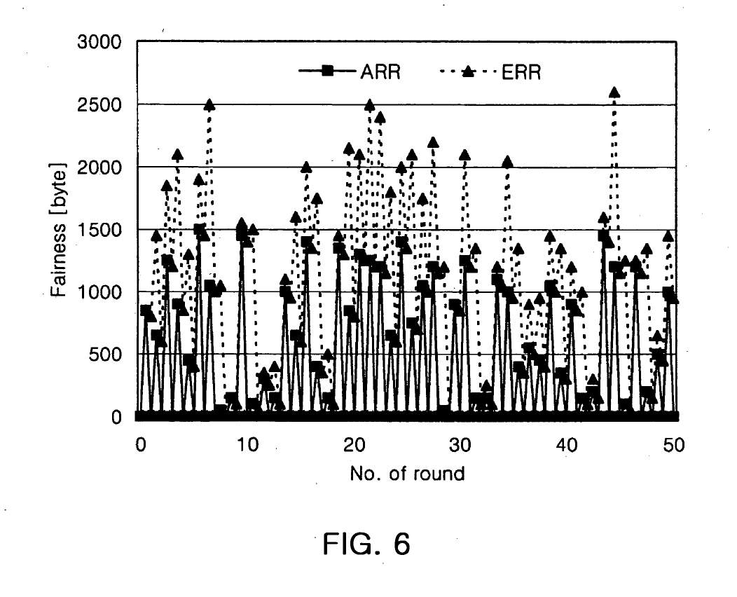

FIG. 6 is a graph of the result of a computer simulation illustrating a difference in fairness between the inventive packet scheduling apparatus and a conventional elastic round-robin (ERR) device according to the present invention.

The simulation shown in FIG. 6 generates packet sizes of two flows in the range from 40 bytes to 1600 bytes at random, always maintains the active state, and shows a difference in service between two flows whenever a service of a single flow is terminated. The conventional ERR method shows a service difference of 2500 bytes or more, but the present invention shows a service difference of 1500 bytes or less. In addition, the ERR method includes 1073 bytes as an average value of a service amount difference, and the present invention includes 377 bytes as an average value of a service amount difference, such that the present invention is superior to the conventional ERR method in the maximum service difference and the average service difference.

As apparent from the above description, the packet scheduling method and apparatus according to the present invention adapts an adaptation round-robin method to various-sized packets over a high-speed communication network sharing limited network resources, and determines an amount of data serviceable in a specific flow for each round, resulting in the implementation of service fairness and low latency.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A packet scheduling method using an adaptation round-robin method comprising the steps of:
a) receiving various-sized packets, and storing the received packets while being classified according to flows on the basis of packet flow information of individual packets;
b) if a flow to be serviced is transitioned from an idle mode to an active mode, adding an identifier (ID) of the corresponding flow to the tail of an active flow list;
c) if the corresponding flow's ID is located at the top of the active flow list, providing a head packet of the corresponding flow;
d) increasing a service count by a predetermined number corresponding to the size of the serviced packet, and establishing a maximum service count;
e) providing the next packet in consideration of the service count of the service flow and a next-packet size; and
f) if the service count of the corresponding flow and the next-packet size are higher than the maximum service count, providing the next flow.

2. The method according to claim 1, further comprising the step of:
g) if a packet exceeding the maximum service count remains in the corresponding flow, adding an identifier (ID) to the tail of the active flow list to provide the next round with the remaining packet, and updating the maximum service count.

3. The method according to claim 1, wherein the maximum service count is compared with the service count, such that it is initialized when an updated value of the maximum service count is higher than a predetermined value.

4. The method according to claim 1, wherein the step e) for providing the next packet includes the steps of:
determining whether the corresponding flow is in an empty state;
if the corresponding flow is not in the empty state, adding the next-packet size to the service count of the corresponding flow, and updating the service count;
comparing the updated service count with the maximum service count; and
if the updated service count is less than the maximum service count, providing the next packet.

5. The method according to claim 4, wherein the step e) for providing the next packet further includes the step of:
if the flow is in the empty state, updating the maximum service count.

6. The method according to claim 1, wherein the step f) for providing the next flow includes the steps of:
if the service count of the corresponding flow and the next-packet size are higher than the maximum service count, adding an identifier (ID) of the next flow to the tail of the active flow list; and
providing a packet of the next flow.

7. The method according to claim 1, further comprising the step of:
if the flows require different bandwidths, assigning different weights to individual flows.

8. A packet scheduling apparatus using an adaptation round-robin method comprising:
a flow queue for receiving various-sized packets, and storing the received packets while being classified according to flows on the basis of packet flow information of individual packets;
a service counter for increasing a service amount by a serviceable packet amount of the individual flows, and establishing a resultant service count;
a maximum service counter for establishing a maximum service count indicative of a maximum service amount of the individual flows; and
an active flow list unit for adding an identifier (ID) of the corresponding flow to the tail of an active flow list when the corresponding flow to be serviced is transitioned from an idle mode to an active mode, controlling a flow from a head flow to output the packets as large as a data amount allowed by the service count of the corresponding flow, and adding an identifier (ID) to the tail of the active flow list when a packet exceeding the maximum service count remains in the output flow, such that the remaining packet is provided to the next round.

9. The apparatus according to claim 8, wherein the maximum service counter updates the maximum service count when a packet exceeding the service count remains in the output flow.

10. The apparatus according to claim 8, wherein the maximum service counter compares the maximum service count with the service count, and initializes the maximum service count when an updated value of the maximum service count is higher than a predetermined value.

11. The apparatus according to claim 8, wherein the active flow list unit adds an identifier (ID) of the next flow to the tail of the active flow list when the service count to which a packet size of the serviced flow is added is higher than the maximum service count,

12. The apparatus according to claim 8, wherein the service counter adds a packet size of the serviced flow to, the established service count, and updates the service count.

13. The apparatus according to claim 8, wherein the flow queue includes a parameter capable of assigning different weights to individual flows when the flows require different bandwidths.
